(19) United States
(12) Patent Application Publication
(10) Pub. No.: US 2024/0330944 A1
(43) Pub. Date: Oct. 3, 2024

(54) CHAT SUPPORT PLATFORM HAVING KEYWORD BASED FUNCTIONALITY

(71) Applicant: Truist Bank, Charlotte, NC (US)

(72) Inventor: Barath Jayaraman, Charlotte, NC (US)

(21) Appl. No.: 18/192,614

(22) Filed: Mar. 29, 2023

(51) Int. Cl. G06Q 30/015

(52) U.S. Cl. CPC G06Q 30/015

(57) ABSTRACT

A computing device, a computer program product, and a computer-implemented method for delivering enhanced financial services and, more particularly, for facilitating a virtual chat communication session with a support agent. A user can request an operation in the virtual chat communication session by typing in a command which includes a keyword and a modifier for the keyword. The command would then be parsed by the computing device and when found to be a valid command, it would then be implemented.

### TECHNICAL FIELD

The present disclosure relates to a computing device, computer program product, and computer-implemented method for delivering digital financial services and, more particularly, for a chat support platform that supports keyword based functionality.

### BACKGROUND

Financial institutions that provide financial services are increasingly providing a greater number of client services. In order to alleviate call and chat density from customers over a network environment, such client services include automated virtual support agents (e.g., chatbots) who supplement human virtual support agents by directly interacting with customers via text chat, phone, instant messaging, etc.

### SUMMARY

The present disclosure relates to a computing device, a computer program product, and a computer-implemented method for delivering enhanced digital financial services over a communication network by providing a digital financial management platform for a client device that includes a virtual chat communication platform that facilitates virtual chat communication sessions with the ability to process requests using keywords.

In accordance with one or more embodiments set forth, illustrated and described herein, an apparatus may comprise one or more processors; and a non-transitory memory including a set of instructions of computer-executable program code, which when executed by the one or more processors, causes the apparatus to, during a virtual chat communication session between a user and a support agent of a financial institution on a chat interface visually displayed on a graphical user interface of a client device of a user executing a mobile application or desktop application associated with the financial institution over a communication network: store a set of possible keywords and a set of possible modifiers for each keyword in the set of possible keywords; receive, from the client device using the virtual chat communication session, a command, the command comprising a keyword and a modifier; determine an operation based on the keyword and the modifier; and implement the operation.

In accordance with the apparatus, the set of instructions, which when executed by the one or more processors, causes determine, whether the keyword is in the set of possible keywords and if not, then cause, on the virtual chat communication session of the client device, display of an error message.

In accordance with the apparatus, the set of instructions, which when executed by the one or more processors, causes determine whether the modifier is in the set of possible modifiers for the keyword, and if no, then cause, on the virtual chat communication session of the client device, display of an error message.

In accordance with the apparatus, the set of instructions, which when executed by the one or more processors, enables the keyword to come before the modifier in the command.

In accordance with the apparatus, the set of instructions, which when executed by the one or more processors, enables the keyword to come after the modifier in the command.

In accordance with the apparatus, the set of instructions, which when executed by the one or more processors, enables a punctuation character, symbol, or mark symbol to separate the keyword from the modifier in the command.

In accordance with the apparatus, the set of instructions, which when executed by the one or more processors, enables the punctuation character, symbol, or mark to be a semicolon.

In accordance with the apparatus, the set of instructions, which when executed by the one or more processors, causes, upon receiving a help request for a particular keyword from the virtual chat communication session on the client device, display in the virtual chat communication session on the client device a list of all possible modifiers in the set of possible modifiers for the particular keyword.

In accordance with the apparatus, the set of instructions, which when executed by the one or more processors, causes the virtual chat communication session on the client device to receive the command from the user via audible speech.

In accordance with one or more embodiments set forth, illustrated and described herein, a computer program product comprising at least one non-transitory computer readable medium having with a set of instructions of computer-executable program code, which when executed by one or more processors of a computing device, causes the computing device to, during a virtual chat communication session between a user and a support agent of a financial institution on a chat interface visually displayed on a graphical user interface of a client device of the user executing a mobile application or desktop application associated with the financial institution over a communication network: store a set of possible keywords and a set of possible modifiers for each possible keyword in the set of possible keywords; receive, from the client device using the virtual chat communication session, a command, the command comprising a keyword and a modifier; determine an operation based on the keyword and the modifier; and implement the operation.

In accordance with the computer program product, the set of instructions, which when executed by the one or more processors, causes determine, whether the keyword is in the set of possible keywords and if not, then causes, on the virtual chat communication session of the client device, display of an error message.

In accordance with the computer program product, the set of instructions, which when executed by the one or more processors, causes determine whether the modifier is in the set of possible modifiers for the keyword, and if not, then causes, on the virtual chat communication session of the client device, display of an error message.

In accordance with the computer program product, the set of instructions, which when executed by the one or more processors, enables the keyword to come before the modifier in the command.

In accordance with the computer program product, the set of instructions, which when executed by the one or more processors, enables the keyword to come after the modifier in the command.

In accordance with the computer program product, the set of instructions, which when executed by the one or more processors, enables a punctuation character, symbol, or mark to separate the keyword from the modifier in the command.

In accordance with the computer program product, the set of instructions, which when executed by the one or more processors, enables the punctuation character, symbol, or mark to be a semicolon.

In accordance with the computer program product, the set of instructions, which when executed by the one or more processors, causes, upon receiving a help request for a particular keyword from the virtual chat communication session on the client device, display in the virtual chat communication session on the client device a list of all possible modifiers in the set of possible modifiers for the particular keyword.

In accordance with the computer program product, the set of instructions, which when executed by the one or more processors, causes the virtual chat communication session on the client device to receive the command from the user via audible speech.

In accordance with one or more embodiments illustrated, set forth, and described herein, a computer implemented method may comprise storing, by one or more financial institution servers associated with a financial institution, a set of possible keywords and a set of possible modifiers for each possible keyword in the set of possible keywords; receiving, by the one or more financial institution servers, from a virtual chat communication session between a user and a support agent displayed on a graphical user interface of a client device executing a mobile application or desktop application associated with the financial institution over a communication network, a command from the client device using the virtual chat communication session, the command comprising a keyword and a modifier; determining, in response to the receiving, an operation based on the keyword and the modifier; and implementing the operation.

In accordance with each respective computer implemented method, further comprising determining, whether the keyword is in the set of possible keywords and if not, then cause, on the virtual chat communication session of the client device, display of an error message.

In accordance with each respective computer implemented method, further comprising determining whether the modifier is in the set of possible modifiers for the keyword, and if no, then cause, on the virtual chat communication session of the client device, display of an error message.

In accordance with each respective computer implemented method, further comprising, enabling the keyword to come before the modifier in the command.

In accordance with each respective computer implemented method, further comprising enabling the keyword to come after the modifier in the command.

In accordance with each respective computer implemented method, further comprising enabling a punctuation character, symbol, or mark to separate the keyword from the modifier in the command.

In accordance with each respective computer implemented method, further comprising enabling the punctuation character, symbol, or mark to be a semicolon.

In accordance with each respective computer implemented method, further comprising causing, upon receiving a help request for a particular keyword from the virtual chat communication session on the client device, display in the virtual chat communication session on the client device a list of all possible modifiers in the set of possible modifiers for the particular keyword.

In accordance with each respective computer implemented method, further comprising, causing the virtual chat communication session on the client device to receive the command from the user via audible speech.

### DRAWINGS

The various advantages of the exemplary embodiments will become apparent to one skilled in the art by reading the following specification and appended claims, and by referencing the following drawings, in which:

FIG. 1 illustrates a communication environment, in accordance with one or more embodiments set forth and described herein.

FIG. 2 illustrates a block diagram of the first client device of FIG. 1.

FIG. 3 illustrates a block diagram of the second client device of FIG. 1.

FIG. 4 illustrates a block diagram of the one or more financial institution servers of FIG. 1.

FIG. 5 illustrates a computer-implemented method for implementing a chat communication session with a virtual support agent, in accordance with one or more embodiments set forth and described herein.

FIG. 6 illustrates a computer-implemented method for implementing a chat communication session with a human virtual support agent, in accordance with one or more embodiments set forth and described herein.

FIG. 7 illustrates a virtual chat communication session between a user and a virtual support agent, in accordance with one or more embodiments set forth and described herein.

FIG. 8 illustrates a virtual chat communication session between a user and a virtual support agent with a user issuing a command, in accordance with one or more embodiments set forth and described herein.

FIG. 9 illustrates a virtual chat session between a user and a virtual support agent with the user asking for help, in accordance with one or more embodiments set forth and described herein.

FIG. 10 illustrates a virtual chat session between a user and a virtual support agent with the user entering an invalid command, in accordance with or more embodiments set forth and described herein.

FIG. 11 illustrates a computer-implemented for processing a command comprising a keyword and a modifier, in accordance with one or more embodiments set forth and described herein.

FIG. 12 illustrates a computer-implemented method for determining whether a command is a valid keyword and modifier combination, in accordance with one or more embodiments set forth and described herein.

### DESCRIPTION

Hereinbelow are example definitions that are provided only for illustrative purposes in this disclosure, and should not be construed to limit the scope of the one or more embodiments disclosed herein in any manner. Some terms are defined below for purposes of clarity. These terms are not rigidly restricted to these definitions. This disclosure contemplates that these terms and other terms may also be defined by their use in the context of this description.

As used herein, “application” relates to software used on a computer (usually by a client and/or client device and can be applications that are targeted or supported by specific classes of machine, such as a mobile application, desktop application, tablet application, and/or enterprise application (e.g., client device application(s) on a client device). Applications may be separated into applications which reside on a client device (e.g., VPN, PowerPoint, Excel) and cloud applications which may reside in the cloud (e.g., Gmail, GitHub). Cloud applications may correspond to applications on the client device or may be other types such as social media applications (e.g., Facebook).

As used herein, “artificial intelligence (AI)” relates to one or more computer system operable to perform one or more tasks that normally require human intelligence, such as visual perception, speech recognition, decision-making, and translation between languages.

As used herein, “machine learning” relates to an application of AI that provides computer systems the ability to automatically learn and improve from data and experience without being explicitly programmed.

As used herein, “computer” relates to a single computer or to a system of interacting computers. A computer is a combination of a hardware system, a software operating system and perhaps one or more software application programs. Examples of a computer include without limitation a personal computer (PC), laptop computer, a smart phone, a cell phone, or a wireless tablet.

As used herein, “client device” relates to any device associated with a user, including personal computers, laptops, tablets, and/or mobile smartphones.

As used herein, “modules” relates to either software modules (e.g., code embodied on a machine-readable medium or in a transmission signal) or hardware modules. Certain embodiments are described herein as including logic or a number of components, modules, or mechanisms. A “hardware module” (or just “hardware”) as used herein is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein. In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as an FPGA or an ASIC. A hardware module may also include programmable logic or circuitry that is temporarily configured by software to perform certain operations. A hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations. Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time. Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access.

As used herein, “network” or “networks” relates to any combination of electronic communication networks, including without limitation the Internet, a local area network (LAN), a wide area network, a wireless network, and a cellular network (e.g., 4G, 5G).

As used herein, “processes” or “methods” are presented in terms of processes (or methods) or symbolic representations of operations on data stored as bits or binary digital signals within a machine memory (e.g., a computer memory). These processes or symbolic representations are examples of techniques used by those of ordinary skill in the data processing arts to convey the substance of their work to others skilled in the art. As used herein, a “process” is a self-consistent sequence of operations or similar processing leading to a desired result. In this context, processes and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information.

As used herein, “processor-Implemented module” relates to a hardware module implemented using one or more processors. The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein.

As used herein, “server” relates to a server computer or group of computers that acts to provide a service for a certain function or access to a network resource. A server may be a physical server, a hosted server in a virtual environment, or software code executing on a platform.

As used herein, “service” or “application” relates to an online server (or set of servers), and can refer to a web site and/or web application.

As used herein, “software” relates to a set of instructions and associated documentations that tells a computer what to do or how to perform a task. Software includes all different software programs on a computer, such as applications and the operating system. A software application could be written in substantially any suitable programming language, which could easily be selected by one of ordinary skill in the art. The programming language chosen should be compatible with the computer by which the software application is to be executed and, in particular, with the operating system of that computer. Examples of suitable programming languages include without limitation Object Pascal, C, C++, CGI, Java, and Java Scripts. Further, the functions of some embodiments, when described as a series of steps for a method, could be implemented as a series of software instructions for being operated by a processor, such that the embodiments could be implemented as software, hardware, or a combination thereof.

As used herein, “sensor” relates to any device, component and/or system that can perform one or more of detecting, determining, assessing, monitoring, measuring, quantifying, and sensing something.

As used herein, “real-time” relates to a level of processing responsiveness that a user, module, or system senses as sufficiently immediate for a particular process or determination to be made, or that enables the processor to keep up with some external process.

As used herein, “user” relates to a consumer, machine entity, and/or requesting party, and may be human or machine.

In accordance with one or more embodiments set forth, illustrated, and described herein, a virtual chat communication platform is provided for a client device of a user having one or more financial accounts residing at one or more financial institution servers of a financial institution. The virtual chat communication platform enables a single user, using a single client device, to participate in multiple simultaneous virtual chat communication sessions with virtual support agents acting on behalf of the financial institution in support of serving the needs of the user. In that way, the user is not forced to cancel or end a first virtual chat communication session in order to commence two or more additional virtual chat communication sessions using the same client device.

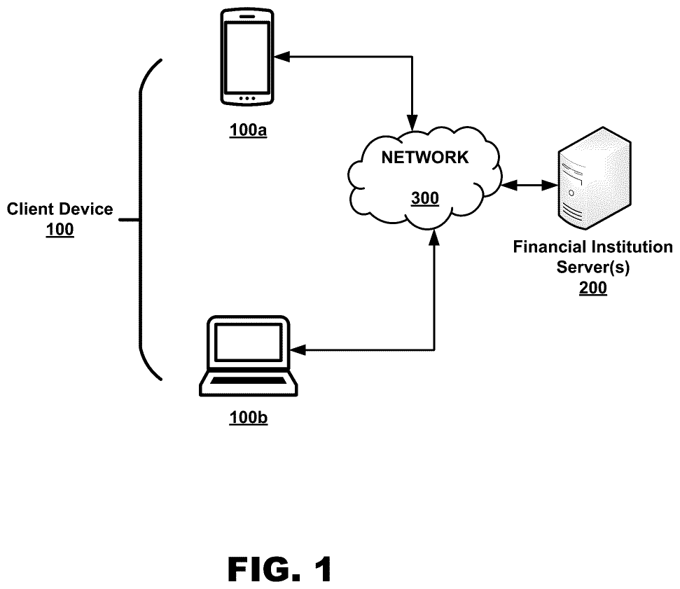

Turning to the figures, in which FIG. 1 illustrates a communication environment that facilitates communications between a user and a financial institution. A client device 100 of a user (financial account holder) operating in the communication environment facilitates user access to and user management of one or more financial accounts residing at one or more financial institution servers 200 of the financial institution. The communication environment includes the client device 100, the one or more financial institution servers 200, and a communication network 300 through which communication is facilitated between the client device 100 and the one or more financial institution servers 200.

In accordance with one or more embodiments set forth, described, and/or illustrated herein, the client device 100 comprises a computing device, including but not limited to a desktop computer, a laptop computer, a smart phone, a handheld personal computer, a workstation, a game console, a cellular phone, a mobile device, a personal computing device, a wearable electronic device, a smartwatch, smart eyewear, a tablet computer, a convertible tablet computer, or any other electronic, microelectronic, or micro-electromechanical device for processing and communicating data. This disclosure contemplates the client device 100 comprising any form of electronic device that optimizes or otherwise transforms the performance and functionality of the one or more embodiments in a manner that falls within the spirit and scope of the principles of this disclosure.

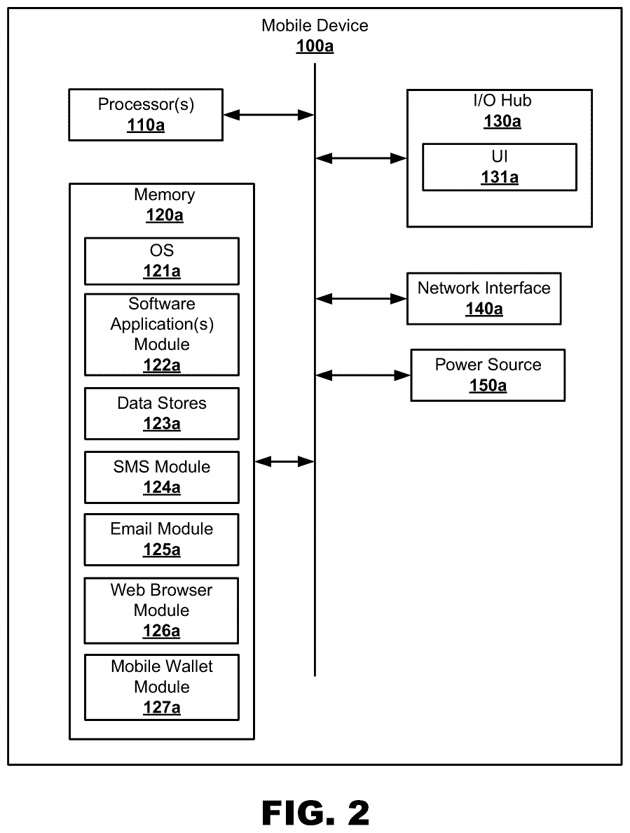

In the illustrated example embodiment of FIG. 2, the client device 100 comprises a mobile device 100a. Some of the possible operational elements of the mobile device 100a are illustrated in FIG. 2 and will now be described herein. It will be understood that it is not necessary for the mobile device 100a to have all the elements illustrated in FIG. 2. For example, the mobile device 100a may have any combination of the various elements illustrated in FIG. 2. Moreover, the mobile device 100a may have additional elements to those illustrated in FIG. 2.

The mobile device 100a includes one or more processors 110a, a non-transitory memory 120a operatively coupled to the one or more processors 110a, an I/O hub 130a, a network interface 140a, and a power source 150a.

The memory 120a comprises a set of instructions of computer-executable program code. The set of instructions are executable by the one or more processors 110a to cause execution of an operating system 121a and one or more software applications of a software application module 122a that reside in the memory 120a. The one or more software applications residing in the memory 120a includes, but is not limited to, a financial institution application that is associated with the financial institution. The financial institution application comprises a mobile application or desktop application that facilitates establishment of a secure connection between the mobile device 100a and the one or more financial institution servers 200. The one or more processors 110a are operable to execute the mobile application or desktop application to facilitate user access to the one or more financial accounts and user management of the one or more financial accounts.

The memory 120a also includes one or more data stores 123a that are operable to store one or more types of data. The mobile device 100a may include one or more interfaces that facilitate one or more systems or modules thereof to transform, manage, retrieve, modify, add, or delete, the data residing in the data stores 123a. The one or more data stores 123a may comprise volatile and/or non-volatile memory. Examples of suitable data stores 123a include, but are not limited to RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable non-transitory storage medium, or any combination thereof. The one or more data stores 123a may be a component of the one or more processors 110a or alternatively, may be operatively connected to the one or more processors 110a for use thereby. As set forth, described, and/or illustrated herein, “operatively connected” may include direct or indirect connections, including connections without direct physical contact.

The memory 120a also includes an SMS module 124a operable to facilitate user transmission and receipt of text messages via the mobile device 100a though the network 300. In one example embodiment, the user may receive text messages from the financial institution that are associated with the user access and the user management of the one or more financial accounts. An email module 125a is operable to facilitate user transmission and receipt of email messages via the mobile device 100a through the network 300. In one example embodiment, the user may receive email messages from the financial institution that are associated with the user access and the user management of the one or more financial accounts. The user may utilize a web browser module 126a that is operable to facilitate user access to one or more websites associated with the financial institution through the network 300. A digital wallet module 127a facilitates the generation of one or more digital wallets associated with the one or more financial accounts.

In accordance with one or more embodiments set forth, described, and/or illustrated herein, the mobile device 100a includes an I/O hub 130a operatively connected to other systems and subsystems of the mobile device 100a. The I/O system 130a may include one or more of an input interface, an output interface, and a network controller to facilitate communications between the mobile device 100a and the one or more financial institution servers 200. The input interface and the output interface may be integrated as a single, unitary user interface 131a, or alternatively, be separate as independent interfaces that are operatively connected.

As used herein, the input interface is defined as any device, software, component, system, element, or arrangement or groups thereof that enable information and/or data to be entered as input commands by a user in a manner that directs the one or more processors 110a to execute instructions. The input interface may comprise a user interface (UI), a graphical user interface (GUI), such as, for example, a display, human-machine interface (HMI), or the like. Embodiments, however, are not limited thereto, and thus, this disclosure contemplates the input interface comprising a keypad, touch screen, multi-touch screen, button, joystick, mouse, trackball, microphone and/or combinations thereof.

As used herein, the output interface is defined as any device, software, component, system, element or arrangement or groups thereof that enable information/data to be presented to a user. The output interface may comprise one or more of a visual display or an audio display, including, but not limited to, a microphone, earphone, and/or speaker. One or more components of the mobile device 100a may serve as both a component of the input interface and a component of the output interface.

The mobile device 100a also includes a network interface 140a operable to facilitate connection to the network 300. The mobile device 100a further includes a power source 150a that comprises a wired powered source, a wireless power source, a replaceable battery source, or a rechargeable battery source.

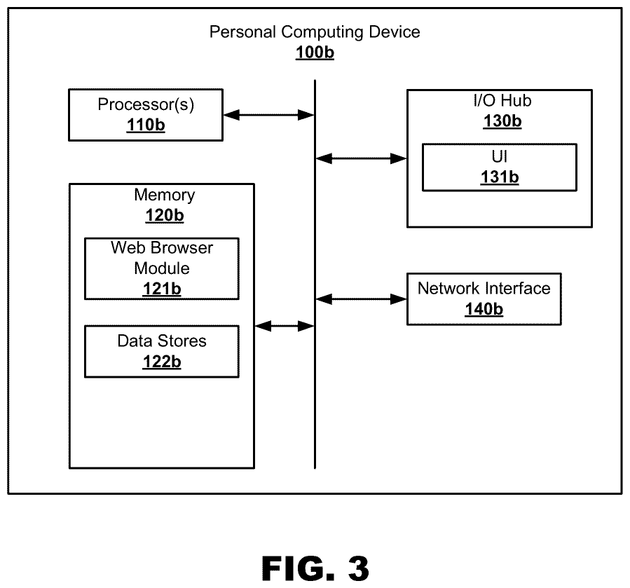

In the illustrated example embodiment of FIG. 3, the client device 100 comprises a personal computing device 100b. Some of the possible operational elements of the personal computing device 100b are illustrated in FIG. 3 and will now be described herein. It will be understood that it is not necessary for the personal computing device 100b to have all the elements illustrated in FIG. 3. For example, the personal computing device 100b may have any combination of the various elements illustrated in FIG. 3. Moreover, the personal computing device 100b may have additional elements to those illustrated in FIG. 3.

The personal computing device 100b includes one or more processors 110b, a non-transitory memory 120b operatively coupled to the one or more processors 110A, an I/O hub 130b, and a network interface 140b.

The memory 120b comprises a set of instructions of computer-executable program code. The set of instructions are executable by the one or more processors 110b to cause control of the web browser module 121b in a manner that facilitates user access to a web browser having one or more websites associated with the financial institution through the network 300.

The memory 120b also includes one or more data stores 122b that are operable to store one or more types of data. The personal computing device 100b may include one or more interfaces that facilitate one or more systems or modules thereof to transform, manage, retrieve, modify, add, or delete, the data residing in the data stores 122b. The one or more data stores 122b may comprise volatile and/or non-volatile memory. Examples of suitable data stores 122b include, but are not limited to RAM

(Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable non-transitory storage medium, or any combination thereof. The one or more data stores 122b may be a component of the one or more processors 110b, or alternatively, may be operatively connected to the one or more processors 110b for use thereby. As set forth, described, and/or illustrated herein, “operatively connected” may include direct or indirect connections, including connections without direct physical contact.

In accordance with one or more embodiments set forth, described, and/or illustrated herein, “processor” means any component or group of components that are operable to execute any of the processes described herein or any form of instructions to carry out such processes or cause such processes to be performed. The one or more processors 100b may be implemented with one or more general-purpose and/or one or more special-purpose processors. Examples of suitable processors include graphics processors, microprocessors, microcontrollers, DSP processors, and other circuitry that may execute software. Further examples of suitable processors include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller. The one or more processors 110b may comprise at least one hardware circuit (e.g., an integrated circuit) operable to carry out instructions contained in program code. In embodiments in which there is a plurality of processors, such processors may work independently from each other, or one or more processors may work in combination with each other.

In accordance with one or more embodiments set forth, described, and/or illustrated herein, the personal computing device 100a includes an I/O hub 130b operatively connected to other systems and subsystems of the personal computing device 100a. The I/O system 130b may include one or more of an input interface, an output interface, and a network controller to facilitate communications between the personal computing device 100a and the one or more financial institution servers 200. The input interface and the output interface may be integrated as a single, unitary user interface 131b, or alternatively, be separate as independent interfaces that are operatively connected.

As used herein, the input interface is defined as any device, software, component, system, element, or arrangement or groups thereof that enable information and/or data to be entered as input commands by a user in a manner that directs the one or more processors 110b to execute instructions. The input interface may comprise a user interface (UI), a graphical user interface (GUI), such as, for example, a display, human-machine interface (HMI), or the like. Embodiments, however, are not limited thereto, and thus, this disclosure contemplates the input interface comprising a keypad, touch screen, multi-touch screen, button, joystick, mouse, trackball, microphone and/or combinations thereof.

As used herein, the output interface is defined as any device, software, component, system, element or arrangement or groups thereof that enable information/data to be presented to a user. The output interface may comprise one or more of a visual display or an audio display, including, but not limited to, a microphone, earphone, and/or speaker. One or more components of the mobile device 100a may serve as both a component of the input interface and a component of the output interface.

The personal computing device 100b also includes a network interface 140b operable to facilitate connection to the network 300.

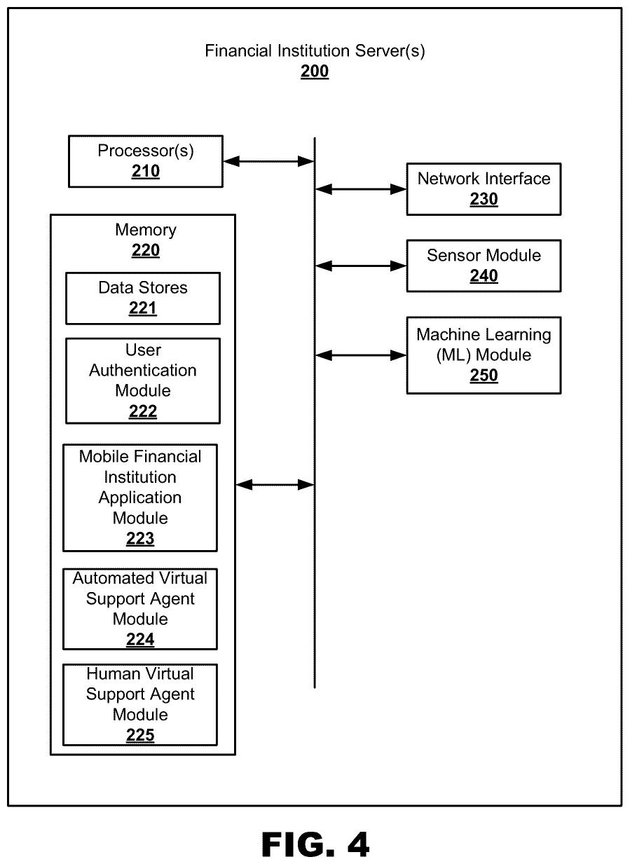

As illustrated in FIG. 4, the one or more financial institution servers 200 includes one or more processors 210, a non-transitory memory 220 operatively coupled to the one or more processors 210, a network interface 230, a sensor module 240, and a machine learning (ML) module 250. Some of the possible operational elements of each server in the one or more financial institution servers 200 are illustrated in FIG. 4 and will now be described herein. It will be understood that it is not necessary for each server in the one or more financial institution servers 200 to have all the elements illustrated in FIG. 4. For example, each server in the one or more financial institution servers 200 may have any combination of the various elements illustrated in FIG. 4. Moreover, each server in the one or more financial institution servers 200 may have additional elements to those illustrated in FIG. 4.

The one or more financial institution servers 200 may be controlled by a system manager (or policy manager) of the financial institution.

In accordance with one or more embodiments set forth, described, and/or illustrated herein, the one or more financial institution servers 200 may comprise a computing device, including but not limited to a server computer, a desktop computer, a laptop computer, a smart phone, a handheld personal computer, a workstation, a game console, a cellular phone, a mobile device, a personal computing device, a wearable electronic device, a smartwatch, smart eyewear, a tablet computer, a convertible tablet computer, or any other electronic, microelectronic, or micro-electromechanical device for processing and communicating data. This disclosure contemplates the one or more financial institution servers 200 comprising any form of electronic device that optimizes or otherwise transforms the performance and functionality of the one or more embodiments in a manner that falls within the spirit and scope of the principles of this disclosure.

The memory 220 comprises a set of instructions of computer-executable program code. The set of instructions are executable by the one or more processors 210 in manner that facilitates control of a user authentication module 222, a mobile financial institution application module 223 having one or more mobile financial institution applications that reside in the memory 220, an automated virtual support agent module 224, and a human virtual support agent module 225. In accordance with one or more embodiments set forth, described, and/or illustrated herein, the one or more financial institution servers 200 may individually or collectively execute the instructions to perform any one or more of the methodologies set forth, described, and illustrated herein.

The memory 220 also includes one or more data stores 221 that are operable to store one or more types of data, including but not limited to, user account data, user authentication data, sensor data, etc. The one or more data stores 221 may comprise volatile and/or non-volatile memory. Examples of suitable data stores 221 include, but are not limited to RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable non-transitory storage medium, or any combination thereof. The one or more data stores 221 may be a component of the one or more processors 210, or alternatively, may be operatively connected to the one or more processors 210 for use thereby. As set forth, described, and/or illustrated herein, “operatively connected” may include direct or indirect connections, including connections without direct physical contact.

The memory 220 may include a single machine-readable medium, or a plurality of media (e.g., a centralized or distributed database, or associated caches and servers) operable to store the instructions. The term “machine-readable medium” shall also be taken to include any medium, or combination of multiple media, that is capable of storing instructions (e.g., software) for execution by a server (e.g., server), such that the instructions, when executed by the one or more processors 210, cause the one or more financial institution servers 200 to perform any one or more of the methodologies set forth, described, and illustrated herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof. The memory 220 can store computer readable program code and data which, when executed by the one or more processors 210 (or other processors) can implement (or cause to be implemented) any of the features and methodologies described herein.

The computer-executable program code may instruct the one or more processors 210 to cause the user authentication module 221 to authenticate a user in order to gain user access to the one or more financial accounts. The user authentication module 221 may be caused to request user input user data or user identification that include, but are not limited to, user identity (e.g., username), a user passcode, a cookie, user biometric data, a private key, a token, and/or another suitable authentication data or information.

The computer-executable program code may instruct the one or more processors 210 to execute certain logic, data-processing, and data-storing functions of the one or more financial institution servers 200, in addition to certain communication functions of the one or more financial institution servers 200. The one or more mobile financial institution applications of the mobile financial institution application module 222 are operable to communicate with the first client device 100a and the second client device 100b in a manner which facilitates user access to the one or more financial accounts in addition to user management of the one or more financial accounts based on successful user authentication.

The sensor module 240 is operable, at least during execution of the mobile application or desktop application by the client device 100, to dynamically detect, determine, assess, monitor, measure, quantify, and/or sense information about the client device 100. The sensor module 240 may be operable to detect, determine, assess, monitor, measure, quantify and/or sense in real-time. The sensor module 240 may be operable to detect, determine, assess, monitor, measure, quantify, and/or sense geographic location information about the geographic location of the client device 100.

The ML module 250 may include one or more ML algorithms to train one or more machine learning models of the one or more financial institution servers 200 based on data and/or information resided in the memory 220. The ML algorithms may include one or more of a linear regression algorithm, a logical regression algorithm, or a combination of different algorithms. A neural network may also be used to train the system based on the received data. The ML module 250 may analyze the received data and/or information, and transform the data and/or information in a manner which provides enhanced communication between the client device 100 and the one or more financial institution servers 200, while also enhancing user access and management of the one or more financial accounts. The data and/or information may also be up-linked to other systems and modules in the one or more financial institution servers 200 for further processing to discover additional information that may be used to enhance the understanding of the information.

In accordance with one or more embodiments set forth, described, and/or illustrated herein, the network 300 may comprise a wireless network, a wired network, or any suitable combination thereof. For example, the network 300 is operable to support connectivity using any protocol or technology, including, but not limited to wireless cellular, wireless broadband, wireless local area network (WLAN), wireless personal area network (WPAN), wireless short distance communication, Global System for Mobile Communication (GSM), or any other suitable wired or wireless network operable to transmit and receive a data signal.

In accordance with one or more embodiments set forth, described, and/or illustrated herein, a user may, via the client device 100, execute a mobile application or desktop application associated with the financial institution over the communication network 300.

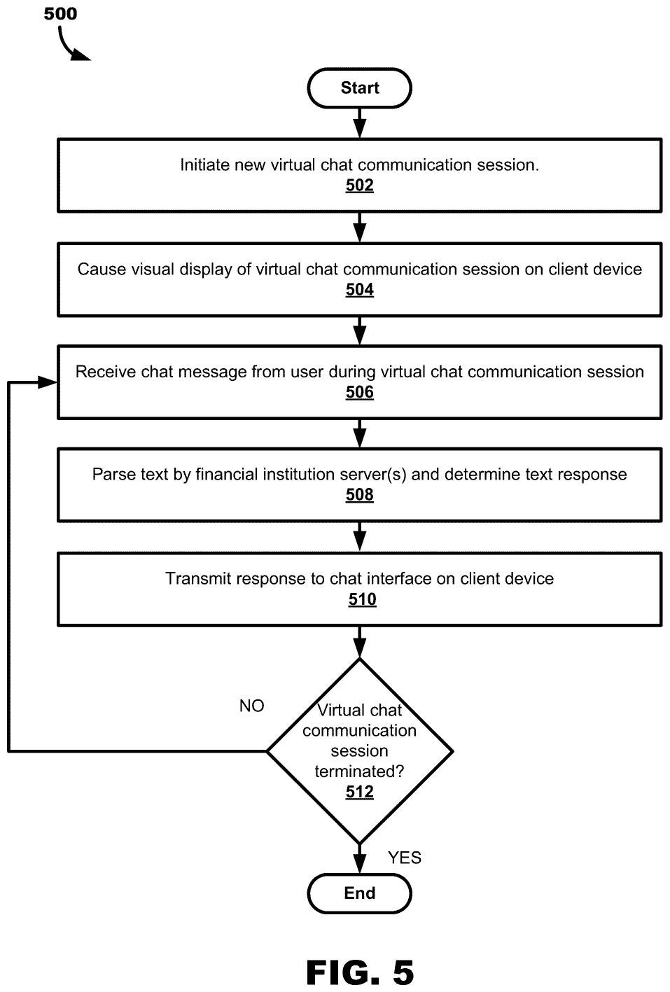

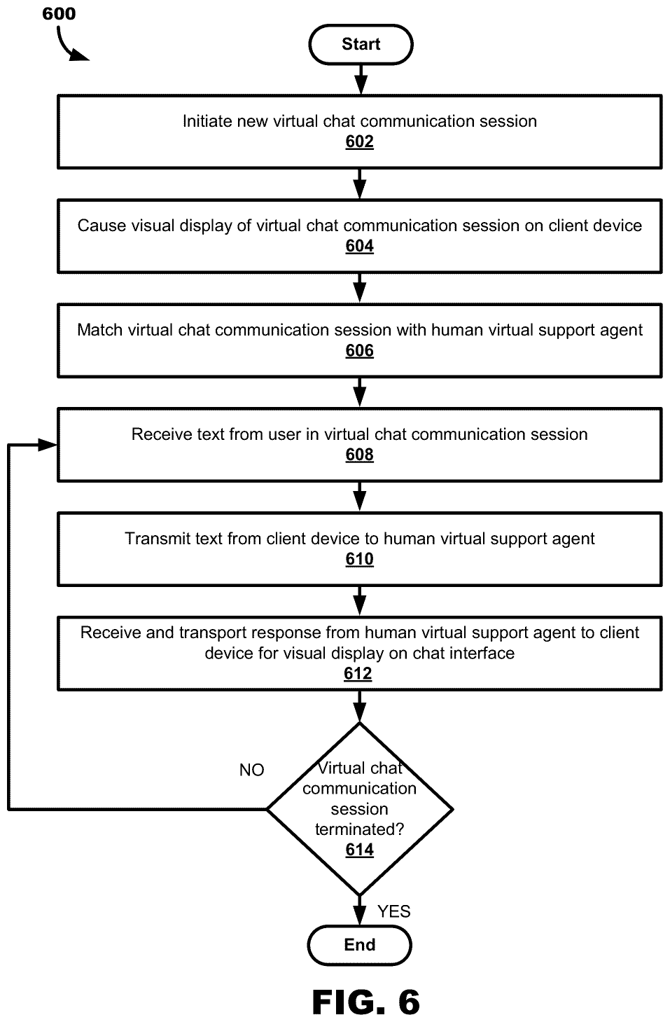

Illustrated examples shown in FIGS. 5 to 6 set forth computer-implemented methods 500 and 600. In one or more examples, the respective flowcharts of the computer-implemented methods 500 and 60 may be implemented by the one or more processors 210 of the one or more financial institution servers 200. In particular, the computer-implemented methods 500 and 600 may be implemented as one or more modules in a set of logic instructions stored in a non-transitory machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality hardware logic using circuit technology such as, for example, application specific integrated circuit (ASIC), complementary metal oxide semiconductor (CMOS) or transistor-transistor logic (TTL) technology, or any combination thereof.

In accordance with one or more embodiments set forth, described, and/or illustrated herein, software executed by the one or more financial institution servers 200 provides functionality described or illustrated herein. In particular, software executed by the one or more processors 210 is operable to perform one or more processing blocks of the computer-implemented methods 500 and 600 set forth, described, and/or illustrated herein, or provides functionality set forth, described, and/or illustrated.

As illustrated in FIG. 5, a computer-implemented method can implement a virtual chat communication session between a user and a virtual support agent, in accordance with one or more embodiments set forth and described herein. Illustrated process block 502 causes the one or more processors 210 to initiate a new dedicated process in order to facilitate a new virtual chat communication session. This initiation may include such operations as allocating memory, adding the new virtual chat communication session to a chat queue (of all virtual chat communication sessions administered by the financial institution server(s) 200), and all other such tasks. From illustrated process block 502, the method proceeds to illustrated process block 504, which causes a new virtual chat communication session to open on the client device 100 by causing software executing on the client device 100 to display a GUI showing the new virtual chat communication session. A virtual chat communication session can be a stand-alone chat interface comprising a chat window, or a chat window superimposed over a chat widget (discussed further herein) or any GUI which functions to facilitate a virtual chat communication session between a user and a virtual support agent. The one or more processors 210 would communicate with a process executing on the client device 100 so that the process (could be an application program executing on the client device, a web browser, the operating system on the client device 100 itself, etc.) instructs the client device 100 to open the new virtual chat communication session by utilizing a GUI on the interface 131a, 131b of the client device 100.

In illustrated process block 506, text is entered (typed, spoken, etc.) into the GUI on the client device 100 and received by the respective application on the client device 100.

From illustrated process block 506, the method 500 proceeds to illustrated process block 508 which transmits the text received from illustrated process block 506 to the financial institution servers(s) 200 and routed to the respective process handling the particular virtual chat communication session.

In illustrated process block 510, the text is parsed (typically by the one or more processors 210 of the financial institution server(s) 200) by separating the words in the text and analyzing the text (using one or more such techniques, such as a rules-based system, a machine learning model (such as a convolution neural network), natural language processing (NLP), text mining, or the like.) A response to the text is generated using the one or more such techniques, which may include querying a database in memory 220 to retrieve the response. For example, should the user provide a text query “what is my account balance,” the text analyzer would analyze the text to determine that there is an unknown quantity needed (the user's account balance), and then query the one or more financial institution server(s) 200 to retrieve the quantity needed (the user's account balance).

After the response is determined, the method 500 proceeds to illustrated process block 512 which then causes a visual display of the response (e.g., “Your balance is $1,000.00”) on the chat interface visually displayed on the user interface 131a, 131b.

The method 500 proceeds to illustrated decision block 514, which determines whether the virtual chat communication session is terminated or not. A number of events may result in termination of the virtual chat communication session, including, but not limited to the user closing the chat window on the client device 100, the user communicating (textually and/or verbally) “end this chat” (or some similar phrase), a human virtual support agent manually terminating the virtual chat communication session, the lapse of a predetermined amount of time (e.g., 10 minutes) without receiving any input from the user on the client device 100, the user logging out of the mobile application or desktop application on the client device 100, etc. Note that if no event has occurred to terminate the virtual chat communication session, then the virtual chat communication session will continue. Should, in illustrated decision block 514, it be determined that the virtual chat communication session is terminated, then the computer-executable program code may instruct the one or more processors 210 to close the virtual chat communication session processes, and the virtual chat communication session would no longer require resources by the financial institution server(s) 200. Should, in illustrated decision block 514, it be determined that the virtual chat communication session has not been terminated, then the method 500 would return to illustrated process block 506.

In accordance with one or more embodiments described herein, a user can engage in multiple virtual chat communication sessions in parallel (i.e., contemporaneously or simultaneously) with different virtual support agents (human or automated) from a financial institution. This can be advantageous because the user may have separate issues to discuss, and while the user is waiting for a response from one virtual support agent, may engage in another virtual chat communication session another virtual support agent to discuss another issue. Executing multiple virtual chat communication sessions in parallel can also be advantageous in that the user can separate different issues into different respective virtual chat communication sessions, avoiding potential confusion of using a single virtual chat communication session to address different issues. Using multiple virtual chat communication sessions can also be advantageous because a user may have one complex issue which requires a human virtual support agent while also having a simple issue which could be addressed by a virtual agent, so utilizing separate virtual chat communication sessions for each (one session with a human virtual support agent and one session with a virtual agent) would preserve resources at the financial institution.

As illustrated in FIG. 6, a computer-implemented method can implement a virtual chat communication session between a user and a human virtual support agent, in accordance with one or more embodiments set forth and described herein. Illustrated process blocks 602 and 604 can be implemented the same as illustrated process blocks 502 and 504, respectively, from FIG. 5.

In illustrated process block 606, the virtual chat communication session for the user is matched with a human virtual support agent. The financial institution may have one or more human virtual support agents having access to the financial institution server(s), and whom have their own client device to facilitate communication with the user via a virtual chat communication session. The computer-executable program code may instruct the one or more processors 210 to match the virtual chat communication session with one of the plurality of human virtual support agents. The matching can be executed randomly, or a human virtual support agent can be selected based on certain criteria (e.g., linguistically compatible with a detected language used by the user, specialized knowledge and/or experience in the financial service being requested by the user, etc.).

The method 600 can proceed to illustrated process block 608, which is typically performed the same as illustrated process block 506 from FIG. 5.

The method 600 can proceed to illustrated process block 610, which includes transmitting the text received from the virtual chat communication session in illustrated process block 608 to the matched human virtual support agent for this respective virtual chat communication session, typically via the one or more financial institution server(s) 200.

Then, in illustrated process block 612, the human virtual support agent may textually or verbally communicate a response (the human virtual support agent could first conduct research of data/information stored in memory 220), which is routed by the one or more processors 210 for display on the user interface 131a, 131b of the client device 100.

The method 600 can then proceed to decision block 614, which determines whether the virtual chat communication session is terminated. This can be done identically to illustrated decision block 514 from FIG. 5. Should it be determined that the virtual chat communication session is terminated, then the chat window visually displayed on the user interface 131a, 131b of the client device 100 is closed (for this particular chat only, any remaining chats would still be active and visually displayed). Should it be determined that the virtual chat communication session is not terminated, the method 600 would return to illustrated process block 608.

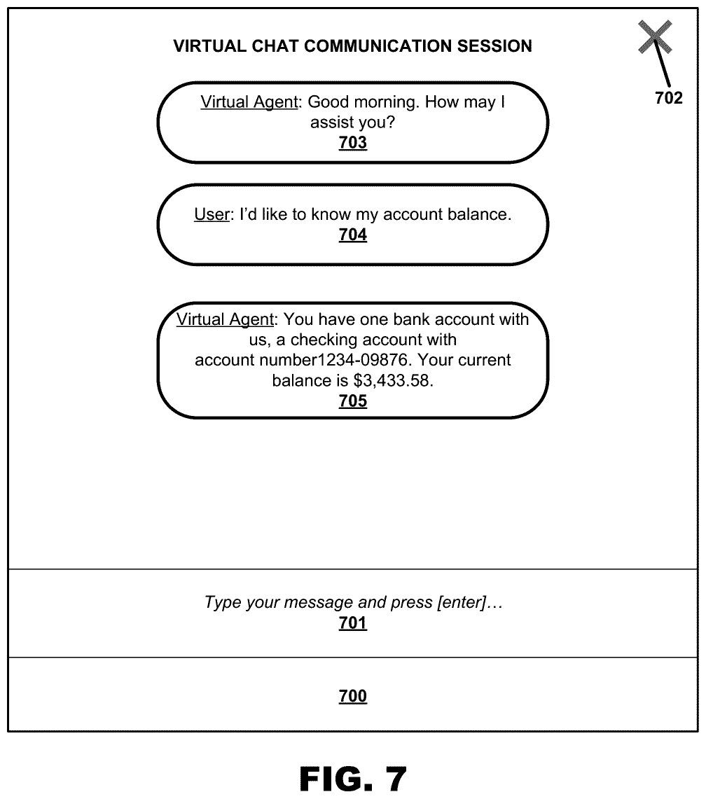

As illustrated in FIG. 7, upon a user launching a financial institution mobile application or desktop application on the client device 100, and being authenticated by the user authentication module 221, the computer-executable program code may instruct the one or more processors 210 to cause a display of a GUI on the user interface 131a, 131b of the client device 100. The GUI comprises a chat interface (e.g., a chat window) 700 that facilitates a virtual chat communication session (e.g., a textual chat or a verbal chat) with a virtual support agent that comprises a plurality of chat messages 703 and 705. A chat box 701 is used for the user to enter chat messages (e.g., queries, commands, etc.) intended for the virtual support agent and also displayed as a chat message above the chat box 701. For example, during the virtual chat communication session, the user may transmit a chat message 704 comprising a general request (verbal or textual) for information. In response to the request/command, the computer-executable program code may instruct the one or more processors 210 to execute analysis or processing (e.g., parsing and/or NLP) of the request/command (chat message 704). This will be executed for all chat messages transmitted by the user via the client device 100. In response to executing or implementing the NLP, the computer-executable program code may instruct the one or more processors 210 to generate a response to the message 704, and then transmit a chat message 705 providing information that was requested by the user. In particular, in response to receipt of the user message 704 for information, the computer-executable program code may instruct the one or more processors 210 to cause a visual display of a chat message 705 on the chat interface visually displayed on the user interface 131a, 131b of the client device 100.

In accordance with one or more embodiments, a command can be entered by a user in the virtual chat communication session. Since human support agents may not always be available, a syntax for commands can be configured in order for the user to communicate their instructions to a virtual support agent. The syntax is easy to learn and thus would reduce errors and frustration on the part of the user when trying to issue commands to the virtual support agent. The syntax can be formed with two words: a keyword following by a semicolon (or other character) following by a modifier. For example, “account; balance.” The keyword would be “account” and the modifier would be “balance.” The keyword can be a subject upon which an operation is performed upon, and the modifier would be a type of operation to perform on (or related to) the keyword. In addition, a keyword can be a type of operation and the modifier would be a further type of the operation and/or what the operation is performed on. In general, the keyword represents a category, and the modifier represents a more narrow application of the category. In this way, a user can easily identify and remember the keyword and modifier combination that the user would need in order to carry out the user's intended transaction. In this example, “account; balance” would result in a balance being displayed on the user's account. If the user has multiple accounts, the keyword can also identify the particular account the user wishes the modifier to apply to (e.g., “account #1234; balance.” While in this example the keyword can come first and the modifier comes after the keyword, in accordance with one or more embodiments, the modifier can come first and the keyword can come second. In addition, while the character separating the keyword from the modifier is shown as a semicolon, in accordance with one or more embodiments, other characters can be used as well (e.g., colon, space, slash, etc.).

In order to parse the syntax, the one or more financial institution servers would store a data structure which comprises a set (list) of valid keywords (which can be stored as text strings) and a set (list) of valid modifiers for each keyword in the list. As an example, Table I below illustrates some exemplary keyword and modifier sets. Each of the keywords would have different functionality based upon the modifier. A help screen can be available to the user to describe each of the keyword and modifier pairs and their specific function. In some cases, additional information may be needed to effectuate the command and the user would be prompted to enter the additional information. For example, if a command “dispute; charge” is entered, this can dispute a charge to the user's account, and the system could automatically prompt the user to enter the particular account the user is referring to and the particular charge (e.g., transaction ID #, amount, etc.) Note all of the keywords have “help” as one of the respective modifiers which would display to the user the list of valid modifiers for the keyword and their respective operations. Note that the set of keywords can also be considered a set of possible keywords because these are the only keywords the system will recognize, and the set of modifiers can also be considered a set of possible modifiers as these are the only modifiers possible for each respective possible keyword. Note that each possible modifier would also have an operation associated with it. For example, keyword “account” and modifier “balance” would have associated with it a computer-implemented operation (which can be stored as a procedure name, pointer, or any other such reference) to implement the operation (on the one or more processors 210 on the financial institution servers 200) associated with the keyword/modifier pair of “account/balance.”

TABLE I

| Keyword | Modifier |
|---|---|
| account | balance, upgrade, transactions, close, help |
| dispute | payment, charge, help |
| credit card | pay, dispute, redeem, help |
| wire | funds, trace, help |

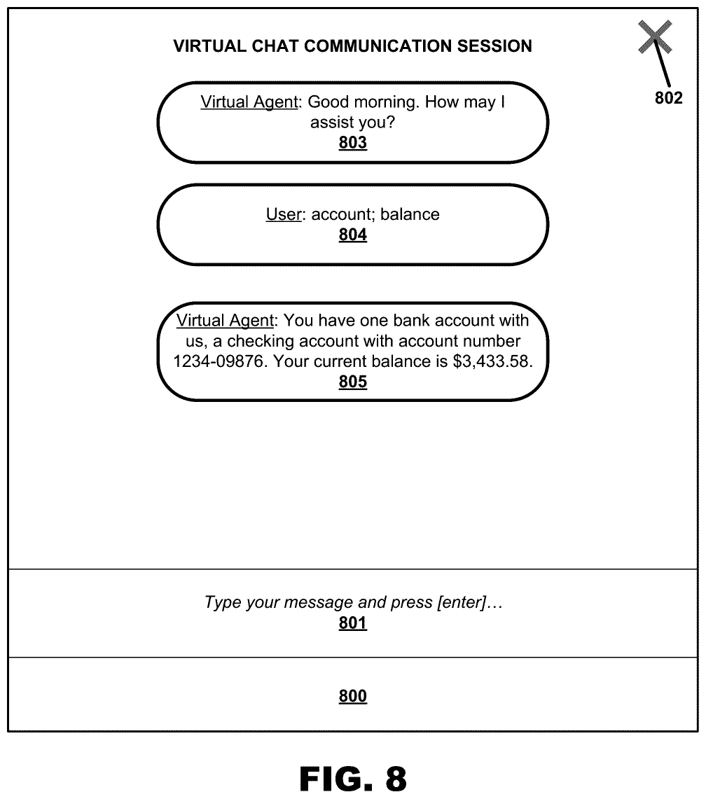

As illustrated in FIG. 8, a virtual chat communication session between a user and a virtual support agent is shown with a user issuing a command, in accordance with one or more embodiments set forth and described herein. A first chat message 803 welcomes the user to the virtual chat communication session. A chat message 804 in the form of a user command (verbal or textual) is transmitted by the user via the client device 100. In response to the request/command, the computer-executable program code may instruct the one or more processors 210 to execute analysis or processing (e.g., parsing and/or NLP) of the request/command (chat message 804). This will be executed for all chat messages transmitted by the user via the client device 100. The user command is analyzed by the financial institution servers 200 to determine the respective operation to be executed, with the results of the operation being transmitted back for visual display on the chat interface 800. In response to executing or implementing the NLP, the computer-executable program code may instruct the one or more processors 210 to generate a response (chat message 805) and then transmit the response for visual display on the chat interface 800. The response contained in chat message 805 includes a result (or confirmation) of the operation which is based upon the user command 804.

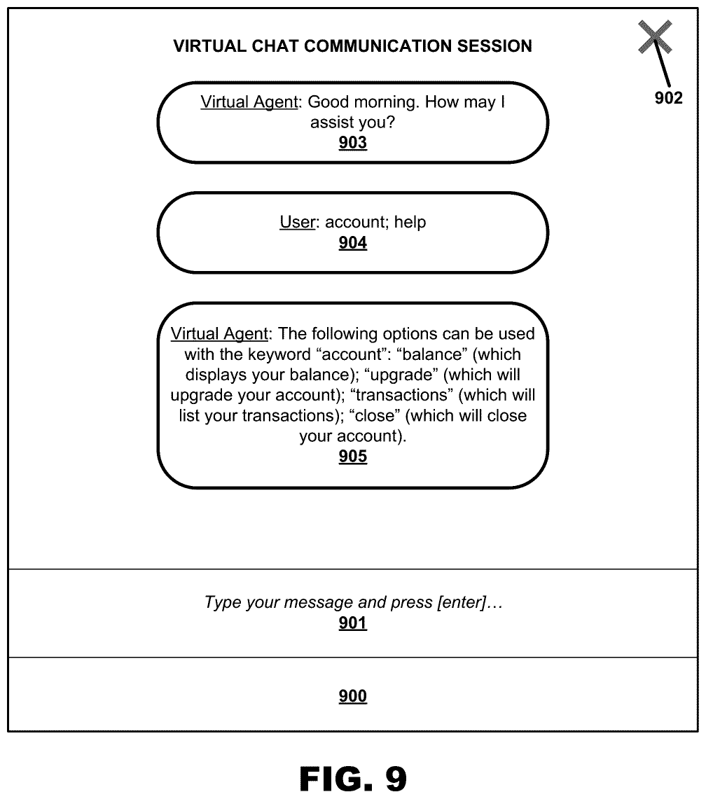

As illustrated in FIG. 9, a virtual chat session between a user and a virtual support agent is shown with the user asking for help, in accordance with one or more embodiments set forth and described herein. The user transmits a chat message 904 in the form of a help request (verbal or textual) by entering “account; help” into the chat box 901. In response to the request/command, the computer-executable program code may instruct the one or more processors 210 to execute analysis or processing (e.g., parsing and/or NLP) of the request/command (chat message 904). This will be executed for all chat messages transmitted by the user via the client device 100. In the chat message 904, the keyword is “account” and the modifier is “help.” In response to executing or implementing NLP, the computer-executable program code may instruct the one or more processors 210 to generate a response and then transmit the response as a chat message 905 which one or more predetermined modifiers for the respective keyword (“account”) and their respective functions.

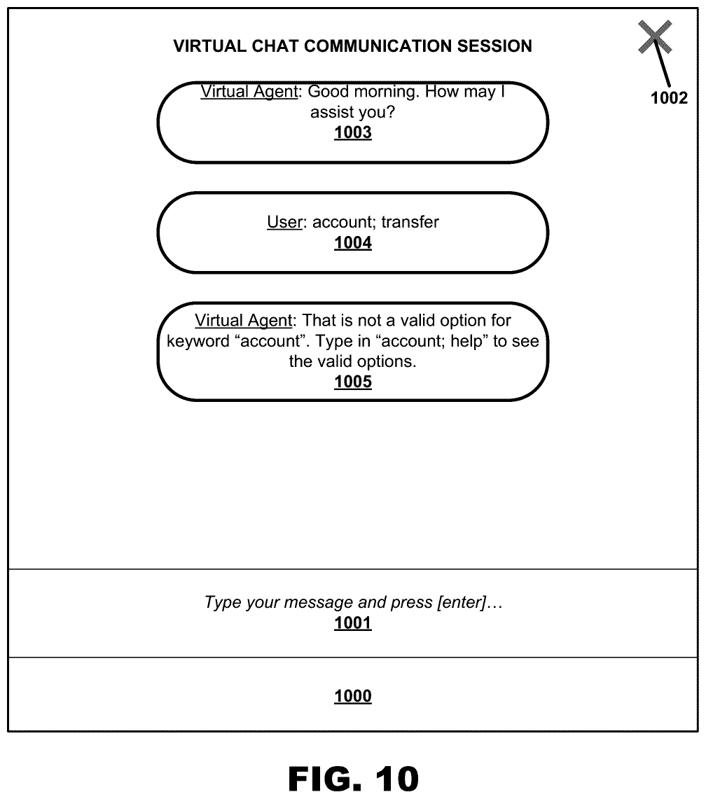

As illustrated in FIG. 10, a virtual chat session between a user and a virtual support agent is shown with the user entering an invalid command, in accordance with or more embodiments set forth and described herein. The user transmits a chat message 1004 in the form of a help request or command (verbal or textual) that includes a modifier (e.g., “transfer”) that is not recognized (e.g., is not set forth in the list of predetermined modifiers) by the financial institution servers 200 for the respective keyword. Assuming the data structure from Table I is being used, then the modifier “transfer” is not listed for keyword “account.” Should this happen, the computer-executable program code may instruct the one or more processors 210 to generate a response and then transmit the response as a chat message 1005 that comprises an error message informing the user that the command was invalid.

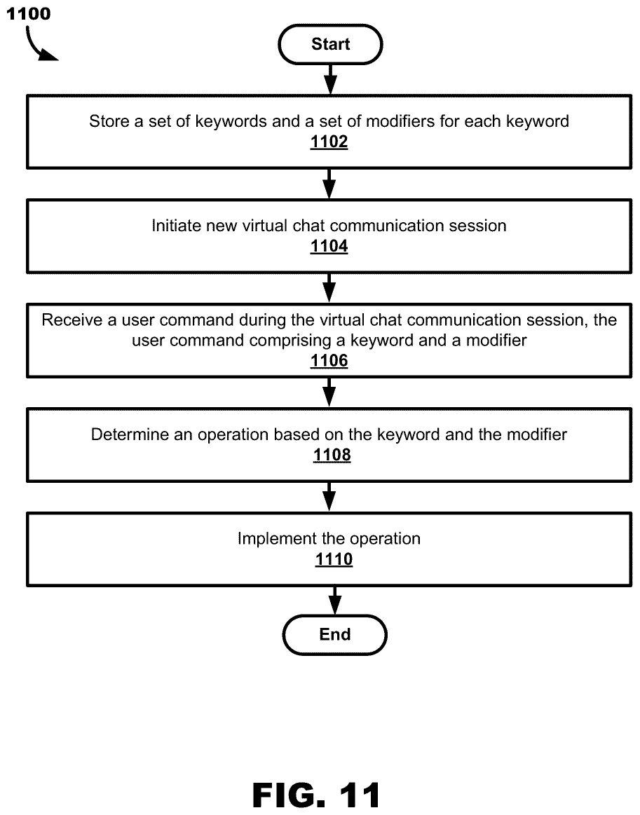

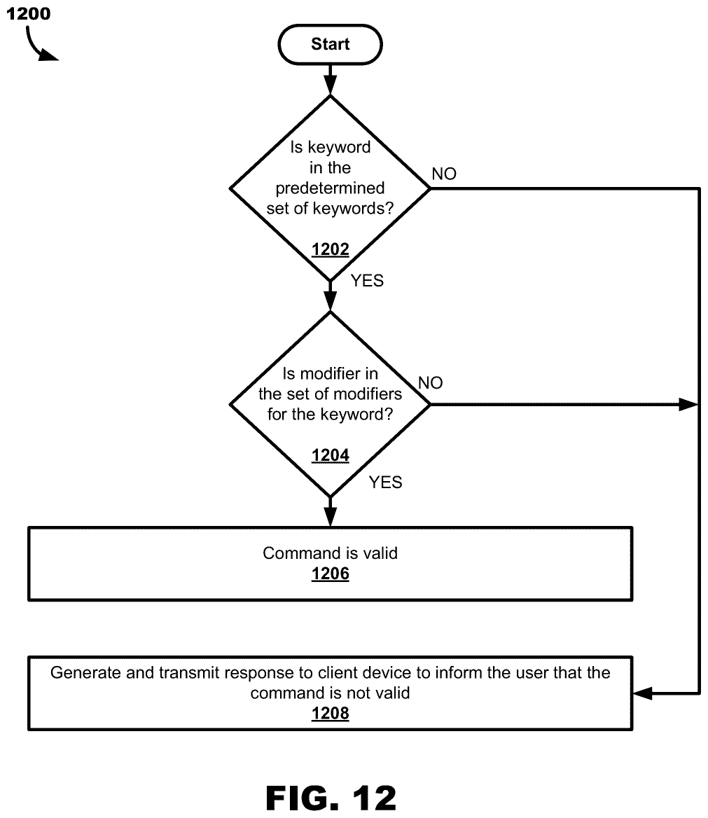

Illustrated example shown in FIGS. 11 and 12 set forth a computer-implemented methods 1100, 1200. In one or more examples, the respective flowcharts of the computer-implemented methods 1100, 1200 may be implemented by the one or more processors 210 of the one or more financial institution servers 200. In particular, the computer-implemented methods 1100, 1200 may be implemented as one or more modules in a set of logic instructions stored in a non-transitory machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality hardware logic using circuit technology such as, for example, application specific integrated circuit (ASIC), complementary metal oxide semiconductor (CMOS) or transistor-transistor logic (TTL) technology, or any combination thereof. It is noted that the computer-implemented methods 1100, 1200 are typically entirely implemented electronically without the need for a human agent.

As illustrated in FIG. 11, a computer-implemented method 1100 is shown for processing a command comprising a keyword and a modifier, in accordance with one or more embodiments set forth and described herein.

In illustrated process block 1102, a predetermined group or set of keywords and associated modifiers for each keyword are stored in a data structure of the one or more financial institution servers 200. For example, a data structure embodying keywords and modifiers such as in Table I can be utilized.

The computer-implemented method 1100 proceeds to illustrated process block 1104, in which a new virtual chat communication session is initiated between the user and the visual support agent and displayed on a chat interface displayed on a user interface 131a, 131b of the client device 101.

The computer-implemented method 1100 can proceed to illustrated process block 1106, in which the financial institution servers 200 receive or otherwise acquire a command from the client device 100 of the user during the virtual chat communication session. A proper command should take the form of a combination of a keyword and a modifier that is associated with the keyword. The one or more processors 210 on the financial institution servers 200 would parse the command and identify the keyword and the modifier. This can be done by separating the word(s) on each side of the punctuation character, symbol, or mark (e.g., semicolon) and the word(s) preceding the punctuation character, symbol, or mark is the keyword and the word(s) following the punctuation character, symbol, or mark is the modifier. An error checking computer-implemented method can be implemented (see FIG. 12) to determine whether the command is proper or not.

If the command is determined to be proper, then the computer-implemented method 1100 can proceed to illustrated process block 1108, in which the computer-executable program code instruct the one or more processors 210 to determine what operation is to be implemented, performed, or executed based upon the keyword/modifier combination of the command. This can be done by utilizing a set of procedures for each valid keyword/modifier combination.

The computer-implemented method 1100 can proceed to illustrated process block 1110, in which the computer-executable program code instruct the one or more processors 210 to implement the operation. Should additional information be needed to implement the operation, then the computer-executable program code may instruct the one or more processors 210 to automatically prompt the user to provide such additional information during the virtual chat communication session.

As illustrated in FIG. 12, a computer-implemented method 1200 is shown for determining whether a command is a valid keyword and modifier combination, in accordance with one or more embodiments set forth and described herein.

In illustrated decision bock 1202, the computer-executable program code instruct the one or more processors 210 to determine if the keyword in the command is in the stored predetermined set of keywords (see illustrated process block 1104 of FIG. 11).

If not, i.e., it is determined that the keyword in the command is not in the stored predetermined set of keywords, then the computer-implemented method 1200 can proceed to illustrated process block 1208, in which the computer-executable program code instruct the one or more processors 210 to generate and transmit a response to the client device 100 informing the user that the command is not valid (i.e., improper).

If the keyword in the command is in the stored predetermined set of keywords, then the computer-implemented method 1200 can proceed to illustrated decision block 1204, which determines whether the modifier is in the predetermined set of modifiers for the keyword.

If not, i.e., it is determined that the modifier is not in the predetermined set of modifiers for the keyword, then the computer-implemented method 1200 can proceed to illustrated process block 1208.

In illustrated process block 1206, it has been determined that the command is not a valid combination of keyword and modifier and an error message can be displayed to the user in the virtual chat communication session (see FIG. 10).

If in decision block 1204 it is determined that the modifier is in the set of modifiers for the keywork, then the computer-implemented method 1200 can proceed to illustrated process block 1206, in which the command is a valid keyword and modifier combination. The m computer-implemented method 1200 can then proceed to illustrated process block 1108 (in FIG. 11) which would determine and implement the operation embodied in the command.

In accordance with one or more embodiments set forth, described, and/or illustrated herein, the client device 100 and the one or more financial institution servers 200 could function in a fully virtualized environment. A virtual machine is where all hardware is virtual and the operation is run over a virtual processor. The benefits of computer virtualization have been recognized as greatly increasing the computational efficiency and flexibility of a computing hardware platform. For example, computer virtualization facilitates multiple virtual computing machines to execute on a common computing hardware platform. Similar to a physical computing hardware platform, virtual computing machines include storage media, such as virtual hard disks, virtual processors, and other system components associated with a computing environment. For example, a virtual hard disk can store the operating system, data, and application files for a virtual machine. Virtualized computer system includes computing device or physical hardware platform, virtualization software executing on hardware platform, and one or more virtual machines executing on hardware platform by way of virtualization software. Virtualization software is therefore logically interposed between the physical hardware of hardware platform and guest system software executing “in” virtual machine.

Memory of the hardware platform may store virtualization software and guest system software executing in virtual machine. Virtualization software performs system resource management and virtual machine emulation. Virtual machine emulation may be performed by a virtual machine monitor (VMM) component. In typical implementations, each virtual machine (only one shown) has a corresponding VMM instance. Depending on implementation, virtualization software may be unhosted or hosted. Unhosted virtualization software generally relies on a specialized virtualization kernel for managing system resources, whereas hosted virtualization software relies on a commodity operating system: the “host operating system,” such as Windows or Linux to manage system resources. In a hosted virtualization system, the host operating system may be considered as part of virtualization software.

The system and method described herein may be at least partially processor-implemented, the one or more processors 210 being an example of hardware. For example, at least some of the operations of the computer-implemented methods may be performed by the one or more processors 210 or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors 210, not only residing within a single machine, but deployed across a plurality of machines. In some example embodiments, the one or more processors 210 or processor-implemented modules may be located in a single geographic location (e.g., within a home environment, an office environment, or a server farm). In other example embodiments, the one or more processors or processor-implemented modules may be distributed across a plurality of geographic locations.

Devices that are described as in “communication” with each other or “coupled” to each other need not be in continuous communication with each other or in direct physical contact, unless expressly specified otherwise. On the contrary, such devices need only transmit to each other as necessary or desirable, and may actually refrain from exchanging data most of the time. For example, a machine in communication with or coupled with another machine via the Internet may not transmit data to the other machine for a long period of time (e.g. weeks at a time). In addition, devices that are in communication with or coupled with each other may communicate directly or indirectly through one or more intermediaries.

The terms “coupled,” “attached,” or “connected” may be used herein to refer to any type of relationship, direct or indirect, between the components in query, and may apply to electrical, mechanical, fluid, optical, electromagnetic, electromechanical, or other connections. Additionally, the terms “first,” “second,” etc. are used herein only to facilitate discussion, and carry no particular temporal or chronological significance unless otherwise indicated. The terms “cause” or “causing” means to make, force, compel, direct, command, instruct, and/or enable an event or action to occur or at least be in a state where such event or action may occur, either in a direct or indirect manner.

Those skilled in the art will appreciate from the foregoing description that the broad techniques of the exemplary embodiments may be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

What is claimed is:

1. An apparatus, comprising:
one or more processors; and
a non-transitory memory coupled to the one or more processors, the non-transitory memory including a set of instructions of computer-executable program code, which when executed by the one or more processors, causes the apparatus to:
store a set of possible keywords and a set of possible modifiers for each keyword in the set of possible keywords;
receive, from a client device of a user during a virtual chat communication session between the user and a virtual support agent of a financial institution when the client device is executing a mobile application or desktop application associated with the financial institution over a communication network, a command that includes a keyword and a modifier;
determine, in response to the command and contemporaneously with the virtual chat communication session, an operation based on the keyword and the modifier; and
implement the operation contemporaneously with the virtual chat communication session.

2. The apparatus of claim 1, wherein the set of instructions, which when executed by the one or more processors, causes the apparatus to determine whether the keyword is in the set of possible keywords.

3. The apparatus of claim 2, wherein the set of instructions, which when executed by the one or more processors, causes the apparatus to cause, contemporaneously with the virtual chat communication session, a visual display on the client device of an error message when it is determined that the keyword is not in the set of possible keywords.

4. The apparatus of claim 2, wherein the set of instructions, which when executed by the one or more processors, causes the apparatus to determine, contemporaneously with the virtual chat communication session, whether the modifier is in the set of possible modifiers for the keyword.

5. The apparatus of claim 4, wherein the set of instructions, which when executed by the one or more processors, causes the apparatus to cause, contemporaneously with the virtual chat communication session, a visual display on the client device of an error message when it is determined that the keyword is not in the set of possible modifiers for the keyword.

6. The apparatus of claim 1, wherein the set of instructions, which when executed by the one or more processors, causes the apparatus to receive, from the client device contemporaneously with the virtual chat communication session, a help request for a particular keyword.

7. The apparatus of claim 6, wherein the set of instructions, which when executed by the one or more processors, causes the apparatus to cause, in response to the help request and contemporaneously with the virtual chat communication session, a visual display on the use interface of the client device of a list of all possible modifiers in the set of possible modifiers for the particular keyword.

8. A computer program product comprising at least one non-transitory computer readable medium having with a set of instructions of computer-executable program code, which when executed by one or more processors of a computing device, causes the computing device to:
store a set of possible keywords and a set of possible modifiers for each keyword in the set of possible keywords;
receive, from a client device of a user during a virtual chat communication session between the user and a virtual support agent of a financial institution when the client device is executing a mobile application or desktop application associated with the financial institution over a communication network, a command that includes a keyword and a modifier, a command that includes a keyword and a modifier;
determine, in response to the command and contemporaneously with the virtual chat communication session, an operation based on the keyword and the modifier; and
implement the operation contemporaneously with the virtual chat communication session.

9. The computer program product of claim 8, wherein the set of instructions, which when executed by the one or more processors, causes the computing device to determine, contemporaneously with the virtual chat communication session, whether the keyword is in the set of possible keywords.

10. The computer program product of claim 9, wherein the set of instructions, which when executed by the one or more processors, causes the computing device to cause, contemporaneously with the virtual chat communication session, a visual display on the client device of an error message when it is determined that the keyword is not in the set of possible keywords.

11. The computer program product of claim 9, wherein the set of instructions, which when executed by the one or more processors, causes the computing device to determine whether the modifier is in the set of possible modifiers for the keyword.

12. The computer program product of claim 11, wherein the set of instructions, which when executed by the one or more processors, causes the computing device to cause, contemporaneously with the virtual chat communication session, a visual display on the client device of an error message when it is determined that the keyword is not in the set of possible modifiers for the keyword.

13. The computer program product of claim 8, wherein the set of instructions, which when executed by the one or more processors, causes the computing device to receive, from the client device contemporaneously with the virtual chat communication session, a help request for a particular keyword.

14. The computer program product of claim 13, wherein the set of instructions, which when executed by the one or more processors, causes the computing device to cause, in response to the help request and contemporaneously with the virtual chat communication session, a visual display on the use interface of the client device of a list of all possible modifiers in the set of possible modifiers for the particular keyword.

15. A computer-implemented method, comprising:
storing, by one or more financial institution servers associated with a financial institution, a set of possible keywords and a set of possible modifiers for each possible keyword in the set of possible keywords;
receiving, by the one or more financial institution servers from a client device of a user during a virtual chat communication session between the user and a virtual support agent of the financial institution when the client device is executing a mobile application or desktop application associated with the financial institution over a communication network, a command that includes a keyword and a modifier, a command that includes a keyword and a modifier;
determining, by the one or more financial institution servers in response to the command and contemporaneously with the virtual chat communication session, an operation based on the keyword and the modifier; and
implementing the operation, by the one or more financial institution servers contemporaneously with the virtual chat communication session.

16. The computer-implemented method of claim 15, further comprising determining, by the one or more financial institution servers contemporaneously with the virtual chat communication session, whether the keyword is in the set of possible keywords.

17. The computer-implemented method of claim 16, further comprising causing, by the one or more financial institution servers contemporaneously with the virtual chat communication session, a visual display on the client device of an error message when it is determined that the keyword is not in the set of possible keywords.

18. The computer-implemented method of claim 16, further comprising determining, by the one or more financial institution servers contemporaneously with the virtual chat communication session, whether the modifier is in the set of possible modifiers for the keyword.

19. The computer-implemented method of claim 18, further comprising causing, by the one or more financial institution servers contemporaneously with the virtual chat communication session, a visual display on the client device of an error message when it is determined that the keyword is not in the set of possible modifiers for the keyword.

20. The computer-implemented method of claim 15, further comprising:
receiving, by the one or more financial institution servers from the client device and contemporaneously with the virtual chat communication session, a help request for a particular keyword, and
causing, by the one or more financial institution servers in response to the help request and contemporaneously with the virtual chat communication session, a visual display on the use interface of the client device of a list of all possible modifiers in the set of possible modifiers for the particular keyword.
